(19) United States
(12) Patent Application Publication
(10) Pub. No.: US 2004/0179554 A1
(43) Pub. Date: Sep. 16, 2004

(54) Method and system of implementing real-time video-audio interaction by data synchronization

(76) Inventor: Hsi-Kang Tsao, Taipei City (TW)

Correspondence Address: RABIN & Berdo, PC, 1101 14TH STREET, NW, SUITE 500, WASHINGTON, DC, 20005, US

(21) Appl. No.: 10/797,006

(22) Filed: Mar. 11, 2004

(30) Foreign Application Priority Data
Mar. 12, 2003 (TW) 92105339

(51) Int. Cl. H04H 1/04

(52) U.S. Cl. 370/486; 370/503

(57) ABSTRACT

A method of implementing real-time video-audio interaction by data synchronization in an Internet game. The inventive method establishes an Internet transmission channel between Internet game clients without connecting to the Internet game sever. First, the method retrieves real-time video and audio data and compresses it into video and audio data packets. Next, the video and audio data packets are packaged into a transmission package. A time stamp is attached to the transmission package for data synchronization. The transmission package is transmitted to other game client through the Internet transmission channel. Finally, the Internet game client receives the transmission package, decompresses the received transmission package into video and audio data, and executes data synchronization according to the time stamp and output thereof.

### BACKGROUND OF THE INVENTION

1. Field of the Invention

The present invention relates to a real-time video-audio interaction technology and in particular to a method of implementing real-time video-audio interaction by data synchronization in an Internet game.

2. Description of the Related Art

Generally speaking, the system architecture of an Internet game comprises an Internet game server and Internet game clients. The Internet game server receives and processes data from the Internet game clients to execute the Internet game. The Internet game clients interact with other Internet game clients and the Internet game. In other words, all the data required by the Internet game is sent to the Internet game server for data processing and data operation. Real-time video-audio interaction utilizes a camera and microphones in an Internet game client to retrieve the real-time data and transmit the retrieved data through the Internet to other Internet game clients for interaction.

Three main technological difficulties limit Internet game systems' support of real-time video-audio interaction. First, current video display technology in an Internet game cannot display a real-time video picture if 3D animation occupies the display. Second, if the compression and transmission of video and audio data are executed solely in the Internet game server, the server becomes overloaded and bandwidth is compromised, affecting the speed of the Internet game. Third, the degree of video and audio data synchronization affects the result in real-time interaction. Hence, presently, real-time video-audio interaction is not supported in an Internet game.

### SUMMARY OF THE INVENTION

Accordingly, an object of the invention is to provide a method of establishing an Internet transmission channel between Internet game clients, compressing and packaging real-time video-audio data in the Internet game clients, and transmitting the packaged data to other Internet game clients. The Internet game client that receives the transmission package, i.e. the recipient Internet game client, decodes the transmission package and applies a module simultaneously supporting real-time video and 3D animation to display the real-time video data when 3D animation occupies the display in an Internet game. In addition, the recipient Internet game client utilizes a sound card, cooperating with audio input or output, to output the real-time audio data back. The module simultaneously supporting real-time video and 3D animation outputs the real-time video data by integrating the real-time video data into game environments of the Internet game as texture mapping, accomplishing simultaneous display.

To achieve the foregoing and other objects, the invention overcomes conventional real-time data interaction problems in an Internet game. In one embodiment, the inventive method first establishes an Internet transmission channel between sender and recipient Internet game clients, without first connecting to an Internet game server. Next, the Internet game clients execute the Internet game and connect to the Internet game server.

Then, real-time video and audio data are retrieved by the sender Internet game client, which then compresses/encodes the retrieved real-time video data into video data frames, compresses/encodes the real-time audio data into audio data packets, packaging both into a transmission package. The transmission package is then transmitted to the recipient Internet game client through the Internet transmission channel. A time stamp is attached in the transmission package for synchronizing the video and audio data.

Finally, the recipient Internet game client decodes the transmission package into real-time video and audio data. The recipient Internet game client synchronizes the real-time video and audio data according to the time stamp, outputs the decoded real-time video data in game environments, and outputs the decoded real-time audio data, achieving real-time video-audio interaction in the Internet game.

### BRIEF DESCRIPTION OF THE DRAWINGS

The present invention can be more fully understood by reading the subsequent detailed description and examples with references made to the accompanying drawings, wherein;

FIG. 1 is a flowchart of the method of implementing real-time video-audio interaction by data synchronization in an Internet game.

FIG. 2 is a diagram of the system of implementing real-time video-audio interaction by data synchronization in an Internet game.

FIG. 3 is a detailed diagram of the system of implementing real-time video-audio interaction by data synchronization in an Internet game.

FIG. 4a, FIG. 4b are diagrams of the method of implementing real-time video-audio interaction by data synchronization in an Internet game,

### DETAILED DESCRIPTION OF THE INVENTION

As summarized above, the present invention provides a system and method overcoming conventional real-time data interaction problems in an Internet game, first establishing an Internet transmission channel between Internet game clients without first connecting to an Internet game server. Next the Internet game clients execute the Internet game and connect to the Internet game server.

The Internet transmission channel is established as follows. First, the sender Internet game client assigns an Internet address of a recipient Internet game client directly or according to a directory which may include all the Internet addresses of possible recipient Internet game clients. The sender Internet game client then transmits a connection request to the recipient Internet game client. The recipient Internet game client establishes the Internet transmission channel in response to the connection request.

Real-time video and audio data are retrieved in the sender Internet game client, which then compresses/encodes the retrieved real-time video data into video data frames, the real-time audio data into audio data packets, packaging both into a transmission package. The transmission package is then transmitted to the recipient Internet game client through the Internet transmission channel.

If the bandwidth of the Internet transmission channel is not sufficient to transmit the real-time video and audio data, the real-time audio data takes priority over real-time video data. The advantage of considering audio data first is that audio data can be highly compressed. Thus, even if the bandwidth of the internet transmission channel is seriously deficient, the smooth of real-time audio data can be maintained, achieving the basic requirement of real-time interaction.

Finally, the recipient Internet game client decodes the transmission package into real-time video and audio data. The recipient Internet game client synchronizes the real-time video and audio data according to the time stamp, outputs the decoded real-time video and audio data in game environments.

One important concern of video-audio data synchronization is maintaining correct time information for data display. If an Internet game client retrieves and displays real-time video-audio data, data synchronization is not a problem because the display time is synchronized to the system time of the Internet game client. If the Internet game client that retrieves real-time data is different from the display client, then the display client has to add the system time and the time stamp together as the display time.

Conversely, because the transmission package considers the audio data first, there may be fewer transmitted video data frames than originally retrieved video data frames. The decompression of the transmission package may also drop some video data frames because of the data compression reference (IP13). Thus, the mentioned time stamp and the amount of real-time video data must be applied to drop video data frames to achieve the expected result of video-audio data synchronization. The data synchronization can be processed before or after the video-audio data decompressing/decoding.

Further, the invention provides a system of implementing real-time video-audio interaction by data synchronization in an Internet game. The inventive system includes an Internet game server and Internet game clients. The Internet game server executes an Internet game main program. The Internet game clients comprise interactive Internet game clients and an Internet transmission channel. The Internet game clients connect to the Internet game server, and the Internet transmission channel connects to the interactive Internet game clients, i.e. the sender and recipient Internet game clients.

The sender Internet game client has a real-time data retriever, data encoder, transmission packager, and Internet sender. The real-time data retriever retrieves real-time video and audio data from the Internet game client. The data encoder compresses/encodes the real-time video data into video data frames, and the real-time audio data into audio data packets. The transmission packager then packages the encoded video and audio data packets into a transmission package. A time stamp is attached to the transmission package. The time stamp enables synchronization between the real-time video and audio data. The Internet sender transmits the transmission package to the recipient Internet game client through the Internet transmission channel.

Here, the Internet transmission channel is established according to the steps mentioned above. Again, if the bandwidth of the Internet transmission channel cannot accommodate the real-time audio and video data simultaneously, the real-time audio data takes priority over the real-time video data.

The recipient Internet game client includes a data decoder and a video-audio playback system. The data decoder decodes the transmission package into real-time video and audio data. The video-audio playback system outputs the decoded video and audio data according the time stamp attached to the transmission package. Similarly, the video-audio playback system integrates the decoded real-time video data into game environments of the Internet game as texture mapping. The data is synchronized by adding the system time of the second internet game client and the time stamp together as the display time of the second real-time video and audio data. Data may also be synchronized comparing the time stamp to the amount of the second real-time video data and the number of frames dropped from the second real-time video data.

Moreover, the invention provides a method of real-time video-audio interaction by data synchronization in an Internet game for application in an Internet game client. The Internet game client first establishes an Internet transmission channel to an external Internet game client without connecting to the Internet game server. The Internet game client then connects to the Internet game server and executes the Internet game.

Thereafter, real-time video and audio data are retrieved by a real-time data retriever and compressed/encoded into a transmission package. A time stamp is attached to the transmission package for data synchronization. The time stamp expresses the synchronous relationship between the real-time video and audio data. The transmission package is transmitted to the external Internet game client through the Internet transmission channel.

The Internet transmission channel is established by a specific procedure. The Internet game client assigns an Internet address to the external Internet game client directly or according to a directory which may include all the Internet addresses of possible external Internet game clients. The Internet game client then transmits a connection request to the external Internet game client. The external Internet game client establishes the Internet transmission channel in response to the connection request. If the bandwidth of the Internet transmission channel cannot support the real-time audio data and video data simultaneously, the real-time audio data takes priority over real-time video data.

The Internet game client receives a transmission package from the external Internet game client through the Internet transmission channel. The Internet game client decompresses/decodes the transmission package into real-time video and audio data. The Internet game client then synchronizes the decoded video and audio data according to the time stamp attached to the transmission package, and outputs the decoded audio and video data in the Internet game.

One embodiment of the invention is directed to a storage medium for storing a computer program, wherein the computer program, when applied to a computer system, implements real-time video and audio interaction by data synchronization between Internet game clients. The method may include the steps mentioned above.

Another embodiment is directed to a computer system of an Internet game, executing an Internet game and having a storage medium for storing a computer program, wherein the computer program is applied to a computer system and implements real-time video-audio interaction by data synchronization between Internet game clients. The method may include the steps mentioned above.

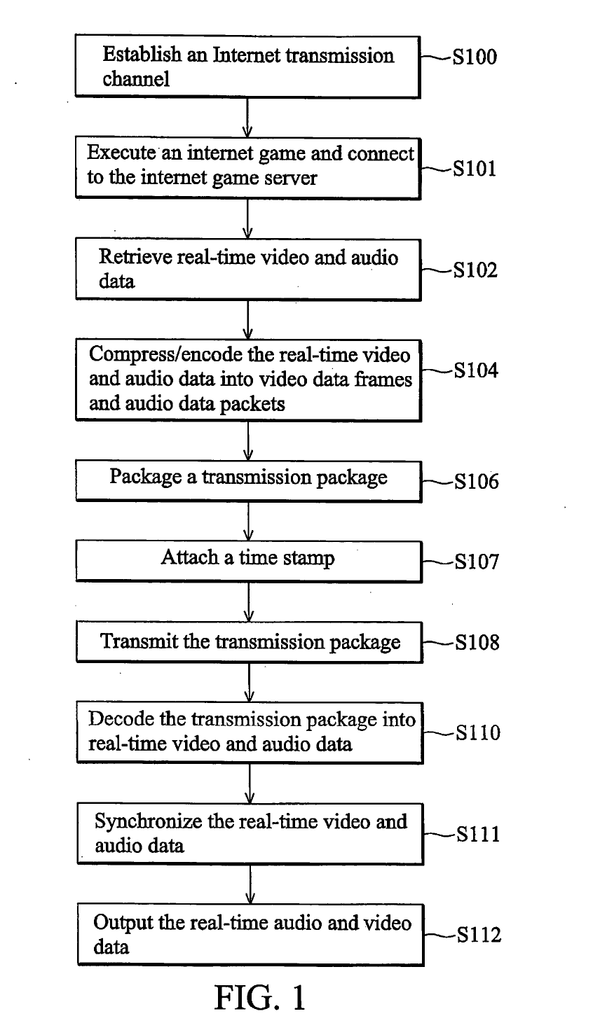

FIG. 1 is a flowchart of the method of implementing real-time video-audio interaction by data synchronization in an Internet game. The method first establishes an Internet transmission channel between clients without connecting to an Internet game server (step S100). The Internet transmission channel can be established by any standard Internet transmission protocol, such as TCP/IP. The establishment of the Internet transmission channel is accomplished by certain steps. The sender Internet game client assigns an Internet address to a recipient Internet game client directly or according to a directory which may include all Internet addresses of possible recipient Internet game clients. The sender Internet game client then transmits a connection request to the recipient Internet game client. The recipient Internet game client establishes the Internet transmission channel in response to the connection request.

Next, the internet game clients connect to the internet game server for executing the internet game (step S101). Real-time video and audio data are retrieved by the sender Internet game client (step S102). The real-time video data may be retrieved by a video capture device, such as a camera. The real-time audio data may be retrieved by an audio capture device, such as a microphone.

The sender Internet game client then compresses/encodes the real-time video data into video data frames, and compresses/encodes the real-time audio data into audio data packets (step S104). Compression can be accomplished by a standard data compression format, such as H.263, MPEG 1/2/4, or G723.

The video and audio data packets are then packaged into a transmission package (step S106). Smooth audio data transmission and the synchronization between video and audio data are the chief concerns of the Internet real-time video-audio data transmission, therefore, the inventive method gives the highest transmission priority to audio data in the transmission package, such that, if the bandwidth of the Internet transmission channel cannot simultaneously support the real-time video and audio data transmission, the audio data takes priority over video data. A time stamp is attached to the transmission package for synchronizing the video and audio data (step S107). The time stamp attached to the transmission expresses the synchronous relationship between the real-time video and audio data, enabling synchronization between the real-time video and audio data. Thus, the inventive method guarantees smooth audio data transmission and accurate synchronization of video and audio data.

The transmission package is then transmitted to the recipient Internet game client through the Internet transmission channel (step S108). Finally, the recipient Internet game client decodes the transmission package into real-time video and audio data (step S110), synchronizes the real-time video and audio data according to the time stamp (step S111), outputs the decoded real-time video data to the Internet game environments, and outputs the decoded real-time audio data (step S112). The real-time interactive video data is integrated into the Internet game environments as texture mapping, to be simultaneously displayed in all the connected game environments as real-time video data.

The data synchronization in the step S111 may be based on the system time of the second internet game client, adding the time stamp, as display time of the second real-time video and audio data. The data synchronization may base on the time stamp and refer to the amount of the second real-time video data to drop data frames of the second real-time video data. Thus, fewer video frames will be displayed in a fixed time period, that is, the display time of each video data frame is prolonged to allow video and audio data synchronization.

The data synchronization of the step S111 can be processed before or after the step S110. If the data synchronization is processed before decoding, the video data frames may be dropped after decoding due to differences between decoders. If the data synchronization is processed after decoding, the dropped video frames are known, thus the number of dropped frames can be controlled.

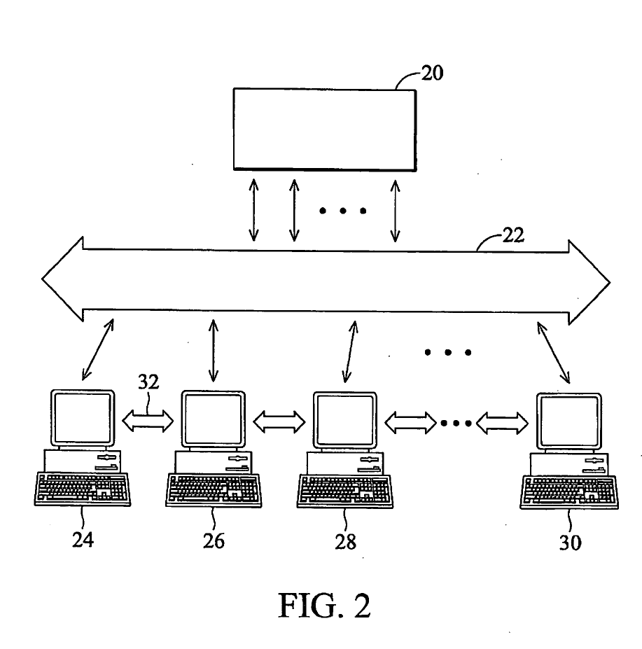

FIG. 2 is a diagram of the system of real-time video-audio interaction by data synchronization in an Internet game of the invention. In one embodiment, the inventive system includes an Internet game server 20 and Internet game clients 24, 26, 28, 30. The Internet game server 20 executes an Internet game main program. The Internet game clients 24, 26, 28, 30, include interactive Internet game clients 24, 26, and an Internet transmission channel 32. The Internet game clients 24, 26, 28, 30, connect to the Internet game server 20 to establish an Internet game network 22. The Internet transmission channel 32 connects to the interactive Internet game clients 24 and 26 without connecting to the Internet game server 20.

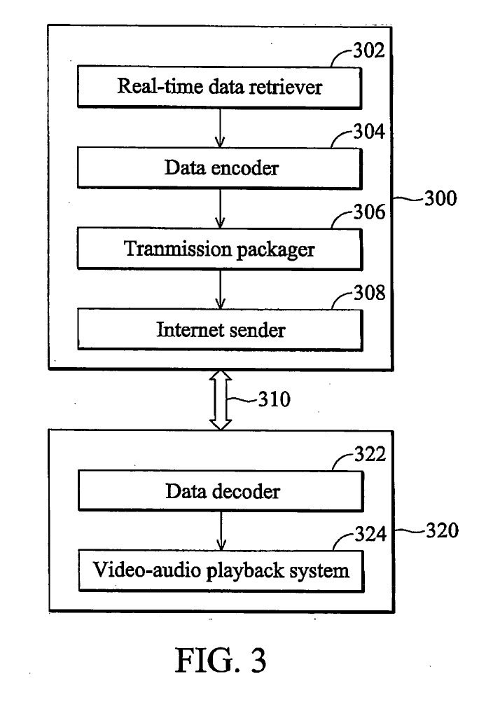

FIG. 3 is a detailed diagram of the system of real-time video-audio interaction by data synchronization in an Internet game. The sender Internet game client 300 has a real-time data retriever 302, a data encoder 304, a transmission packager 306, and an Internet sender 308. The real-time data retriever 302 retrieves real-time video and audio data from the Internet game client 300, The real-time data retriever 302 may comprise separate devices retrieving and processing video and audio data separately or an integrated device, The real-time data retriever 302 can be any data capture device, such as a camera or microphone.

The data encoder 304 compresses/encodes the real-time video data into video data frames, and the real-time audio data into audio data packets. The data encoder 304 may comprise separate devices to compress/encode video and audio data separately or an integrated device.

The transmission packager 306 assigns the audio frames highest transmission priority and packages the video frames and audio data packets into a transmission package. A time stamp is attached to the transmission package. The time stamp expresses the synchronous relationship between the video and audio data, that is, the time information of producing video and audio. The Internet sender 308 transmits the transmission package to the recipient Internet game client 320 through the Internet transmission channel 310. As an example, the transmission packager 306, the Internet sender 308, and the Internet transmission channel 310 can be implemented by programming into computer-executive modules in program languages to achieve the operations described.

The recipient Internet game client 320 includes a data decoder 322 and a video-audio playback system 324. The data decoder 322 decodes the transmission package into real-time video and audio data. Here, the data decoder 322 can comprise separate devices or be an integrated device. The data encoder 304 and the data decoder 322 may be implemented by programming into computer-executive modules in program languages to achieve the mentioned functions.

The video-audio playback system 324 synchronizes the decoded video and audio data according to the attached time stamp. The video-audio playback system 324 integrates the decoded real-time video data into game environment of the Internet game as texture mapping. The video-audio playback system 324 outputs the real-time audio data by a sound card with audio input or output. The real-time video-audio interaction between the Internet game clients is bi-directional, that is, the Internet game clients for real-time video-audio interaction are provided with both sender and recipient functions. All components and functions of both sender and recipient are provided in the sender Internet game client 300 and the recipient Internet game client 320.

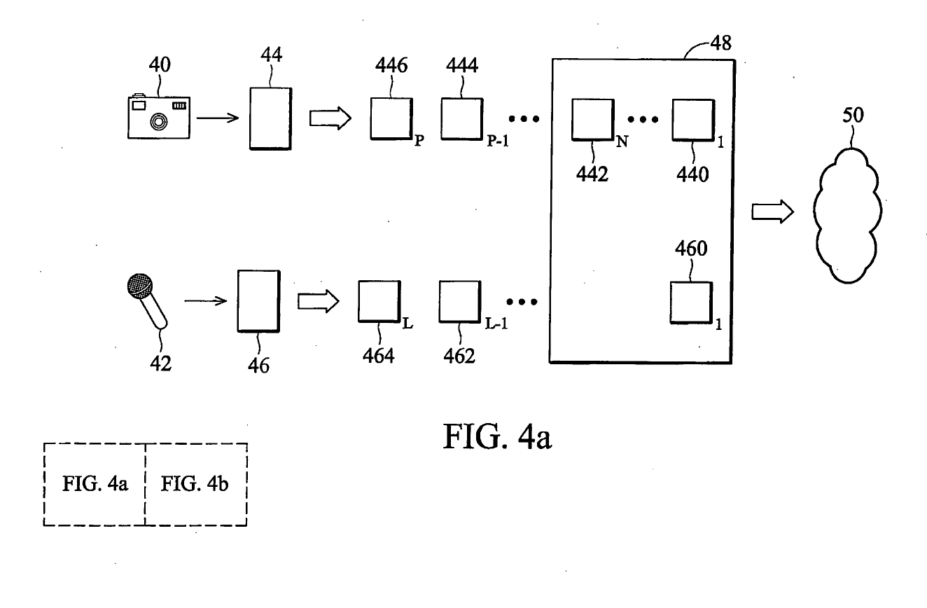

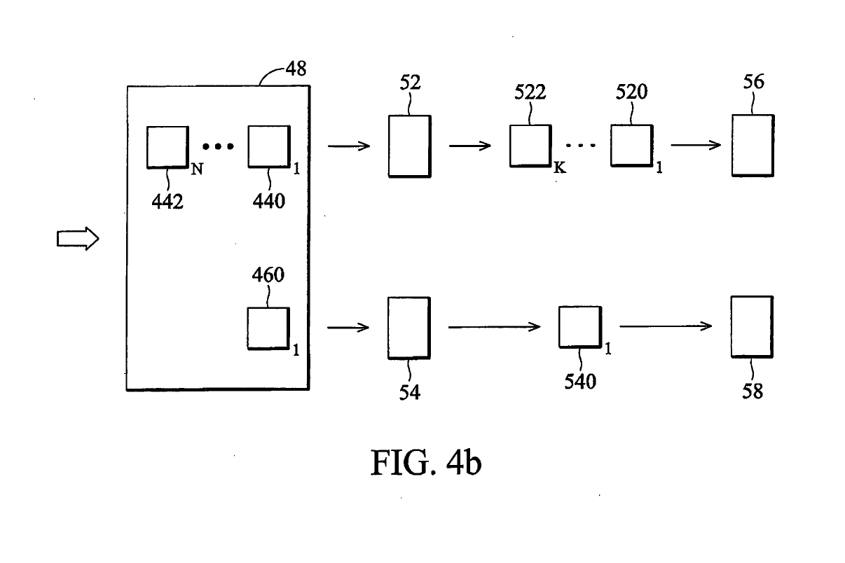

FIG. 4a, FIG. 4b are diagrams of the method of implementing real-time video-audio interaction by data synchronization in an Internet game. An Internet transmission channel 50 is established for transmission. The camera 40 retrieves real-time video data and microphone 42 retrieves real-time audio data.

The data encoder 44, 46, compresses/encodes the real-time video data into video data frames, 440, 442, 444, 446, P frames. The data encoder 44, 46, also compresses/encodes the real-time audio data into audio data packets 460, 462, 464, L packets. The audio data packet takes priority over the video data frames. The video data frames and audio data packets are packaged into a transmission package 48. In other words, the audio data frame 460 is packaged first into the transmission package in one fixed time period and the video data frames 440, 442 are then packaged according to remaining bandwidth. If only N video data frames are packaged into the transmission package, then (P-N) video data frames are not. A time stamp is attached to the transmission package. The time stamp expresses the synchronous relationship between the video and audio data.

Through the Internet transmission channel 50, the sender Internet client transmits the transmission package 48 to the recipient Internet game client. The data decoders 52 and 54 decode the transmission package 48 into real-time video data 520 to 522 and real-time audio data 540. The Internet transmission may drop some video frames, only M video frames are received (M<=N). Obviously, the number of video data frames 440 to 442 is equal to or larger than the number of video data frames 520 to 522. The video decompression method, such as IPB mode, may also cause video data frame drop such that only K (K<=M) video data frames are decompressed. Audio frames 540 are decompressed completely. Thus, the first package mechanism ensures smooth audio transmission and accurate synchronization of the video and audio data.

The video-audio playback systems 56 and 58, display the decoded video data by simultaneous support of real-time video and 3D animation, outputting real-time video data to game environments as texture mapping. The video-audio displayers 56 and 58, may synchronize data by adding the system time of the second internet game client to the time stamp and generating the display time of the second real-time video and audio data. Alternately, the video-audio displayers 56 and 58 may display synchronized data by comparing the time stamp to the number of frames dropped by the second real-time video data. The data synchronization can be accomplished before or after the data has been decoded by the decoders 52 and 54. The video-audio playback systems 56, 58, output audio data via a sound card with audio input or output 58, achieving real-time video-audio interaction.

The methods and systems provided by the present invention can be independent from an Internet game system by establishing an Internet transmission channel between Internet game clients. In addition, the invention applies the first audio data package mechanism and an attached time stamp to achieve smooth audio transmission and accurate synchronization of the video and audio data, accomplishing real-time video-audio interaction by data synchronization in an Internet game. The invention enhances the reality of the Internet game without further burdening the Internet game server, resolving problems of the existing technology.

It will be appreciated from the foregoing description that the system and method described herein provide a dynamic and robust solution to real-time video-audio interaction problems. If, for example, an Internet game client changes data capture devices, the system and method of the present invention can be revised accordingly.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of implementing real-time video-audio interaction by data synchronization in an Internet game, comprising the steps of:
establishing an Internet transmission channel between a first internet game client and a second internet game client, wherein the Internet transmission channel is not connected to an Internet game server;
executing an internet game in the first Internet game client and the second internet game client and connecting the first and second Internet game clients to the internet game server;
retrieving first real-time video data and first real-time audio data in the first internet game client in the Internet game;
compressing/encoding the first real-time video data into a plurality of first video data frames, and compressing/encoding the first real-time audio data into a plurality of first audio data packets in the first Internet game client;
packaging the first video data frames and the first audio data packets into a transmission package in the first Internet game client and attaching a time stamp to transmission package, wherein the time stamp expresses the synchronous relationship between the first real-time video and audio data;
transmitting the transmission package to the second Internet game client through the Internet transmission channel;
decoding the transmission package into second real-time video data and second real-time audio data in the second Internet game client; and
synchronizing the second real-time video and audio data according to the time stamp, and outputting the second real-time audio and video data in the second Internet game client in the Internet game.

2. The method as claimed in claim 1, wherein the establishment of the Internet transmission channel further comprises the steps of:
designating an Internet address of the second Internet game client directly or according to a directory by the first Internet game client, wherein the directory includes the Internet address of the second Internet game client;
transmitting a connection request from the first Internet game client to the second Internet game client; and
establishing the Internet transmission channel by the second Internet game client in response to the connection request.

3. The method as claimed in claim 1, wherein it the bandwidth of the Internet transmission channel cannot transmit the first real-time audio data and the first real-time video data simultaneously, the first real-time audio data takes priority over first real-time video data.

4. The method as claimed in claim 1, wherein the time stamp provides is time information required to produce the first real-time video data and the first real-time audio data.

5. The method as claimed in claim 1, wherein the synchronization is achieved by adding the system time of the second internet game client to the time stamp to generate the display time of the second real-time video and audio data.

6. The method as claimed in claim 1, wherein synchronization is achieved by comparing the time stamp the amount of the frames dropped by the second real-time video data.

7. The method as claimed in claim 1, wherein playback of the second real-time video data is accomplished by integrating the second real-time video data into the game environments of the Internet game as texture mapping.

8. A system of implementing real-time video-audio interaction by data synchronization in an Internet game, comprising:
an Internet game server, executing an Internet game; and
a plurality of Internet game clients, comprising a first Internet game client, a second Internet game client, and an Internet transmission channel, the first and the second Internet game clients connecting to the Internet game server, the Internet transmission channel coupled to the first Internet game client and the second Internet game client

9. The system as claimed in claim 8, wherein the first internet game client further comprises:
a real-time data retriever, retrieving first real-time video data and first real-time audio data from the first Internet game client;
a data encoder, coupled to the real-time data retriever, compressing/encoding the first real-time video data into a plurality of first video data frames, and compressing/encoding the first audio data into a plurality of first audio data packets;
a transmission packager, coupled to the data encoder, packaging the first video data frames and the first audio data packets into a transmission package and attaching a time stamp into the transmission package, wherein the time stamp expresses the synchronous relationship between the first real-time video data and the first real-time audio data; and
an Internet sender, coupled to the transmission packager, transmitting the transmission package to the second Internet game client through the Internet transmission channel.

10. The system as claimed in claim 9, wherein if the bandwidth of the Internet transmission channel cannot transmit the first real-time audio data and the first real-time video data simultaneously, the first real-time audio data takes priority over first real-time video data.

11. The system as claimed in claim 9, wherein the time stamp provides the time information required to produce the first real-time video data and the first real-time audio data.

12. The system as claimed in claim 8, wherein the second Internet game client further comprises:
a data decoder, coupled to the Internet transmission channel, decoding the transmission package into second video data and second audio data;
a video-audio playback system, coupled to the data decoder, synchronizing the second real-time video and the second real-time audio data according to the time stamp and outputting the second video data and the second audio data.

13. The system as claimed in claim 12, wherein synchronization is achieved by adding the system time of the second internet game client to the time stamp to generate the display time of the second real-time video and audio data.

14. The system as claimed in claim 12, wherein synchronization is achieved by comparing the time stamp the amount of the frames dropped by the second real-time video data.

15. The system as claimed in claim 12, wherein the video-audio playback system integrates the second real-time video data into the game environments of the Internet game as texture mapping.

16. The system as claimed in claim 8, wherein the internet transmission channel is established by assigning an Internet address to the second Internet game client directly or according to a directory by the first Internet game client, transmitting a connecting request from the first Internet game client to the second Internet game client, and the second Internet game client establishing the Internet transmission channel according to the connecting request, wherein the directory includes the Internet address of the second Internet game client.

17. A method of implementing real-time interaction by video-audio synchronization between Internet game clients, wherein the Internet game client connects to an Internet game server, and executes an Internet game, comprising the steps of:
establishing an Internet transmission channel to an external Internet game client, wherein the Internet transmission channel is not connected to the Internet game server;
a real-time data retriever retrieving first real-time video data and first real-time audio data;
compressing/decoding the first real-time video data and the first real-time audio data into a first transmission package and attaching a time stamp to the transmission package, wherein the time stamp expresses the synchronous relationship between the video and audio data;
transmitting the first transmission package through the Internet transmission channel;
receiving a second transmission package through the Internet transmission channel;
decompressing/decoding the second transmission package into second real-time video data and second real-time audio data; and
synchronizing the second real-time video and the second real-time audio data according to the time stamp, and outputting the second real-time audio data and video data in the game environment.

18. The method as claimed in claim 17, wherein the establishment of the Internet transmission channel further comprises the steps of:
designating an Internet address of a third external Internet game client by the Internet game client or the external Internet game client;
transmitting a connecting request to the third Internet game client by the Internet game client or the external Internet game client according to the Internet address; and
establishing the Internet transmission channel between the Internet game client and the third Internet game client.

19. The method as claimed in claim 17, wherein if the bandwidth of the internet transmission channel cannot transmit the first real-time audio data and the first real-time video data simultaneously, the first real-time audio data takes priority over first real-time video data.

20. The method as claimed in claim 17, wherein in the establishing step, the Internet transmission channel is established according to a directory, having an Internet address of the third external Internet game client.

21. The method as claimed in claim 17, wherein synchronization is achieved by adding the system time of the second internet game client to the time stamp to generate the display time of the second real-time video and audio data.

22. The method as claimed in claim 17, wherein synchronization is achieved by comparing the time stamp the amount of the frames dropped by the second real-time video data.

23. The method as claimed in claim 17, wherein playback of the second video data is accomplished by integrating the second real-time video data into the game environment as texture mapping.

24. A storage medium for storing a computer program providing a method of implementing real-time video-audio interaction by data synchronization between Internet game clients, wherein the Internet game client connects to an Internet game server, and executes an Internet game, the computer program comprising using a computer to perform the steps of:
establishing an Internet transmission channel to an external Internet game client, wherein the Internet transmission channel is not connected to the Internet game server;
a real-time data retriever retrieving first real-time video data and first real-time audio data;
compressing/decoding the first real-time video data and the first real-time audio data into a first transmission package, and attaching a time stamp into the transmission package, wherein the time stamp expresses the synchronous relationship between the video and audio data;
transmitting the first transmission package through the Internet transmission channel;
receiving a second transmission package through the Internet transmission channel;
decompressing/decoding the second transmission package into second real-time video data and second real-time audio data; and
synchronizing the second real-time video and the second real-time audio data according to the time stamp, and outputting the second real-time audio data and video data in the game environment.

25. The method as claimed in claim 24, wherein the establishment of the Internet transmission channel further comprises the steps of:
designating an Internet address of a third external Internet game client by the Internet game client or the external Internet game client;
a transmitting a connecting request to the third Internet game client by the Internet game client or the external Internet game client according to the Internet address; and
establishing the Internet transmission channel between the Internet game client and the third Internet game client.

26. The method as claimed in claim 24, wherein if the bandwidth of the internet transmission channel cannot transmit the first real-time audio data and the first real-time video data simultaneously, the first real-time audio data takes priority over first real-time video data.

27. The method as claimed in claim 24, wherein in the establishing step, the Internet transmission channel is established according to a directory, having an Internet address of the third external Internet game client.

28. The method as claimed in claim 24, wherein synchronization is achieved by adding the system time of the second internet game client to the time stamp to generate the display time of the second real-time video and audio data.

29. The method as claimed in claim 24, wherein synchronization is achieved by comparing the time stamp the amount of the frames dropped by the second real-time video data.

30. The method as claimed in claim 24, wherein playback of the second video data is accomplished by integrating the second real-time video data into the game environment as texture mapping.

31. A computer system of an Internet game, executing an Internet game and having a storage medium for storing a computer program, wherein the computer program is applied to a computer system and executes the method of real-time video-audio interaction between Internet game clients, the Internet game client connecting to an Internet game server, executing an Internet game, and outputting a game environment, the method comprising the steps of:
establishing an Internet transmission channel to an external Internet game client, wherein the Internet transmission channel is not connected to the Internet game server;
a real-time data retriever retrieving first real-time video data and first real-time audio data;
compressing/decoding the first real-time video data and the first real-time audio data into a first transmission package, and attaching a time stamp into the transmission package, wherein the time stamp expresses the synchronous relationship between the video and audio data;
transmitting the first transmission package through the Internet transmission channel;
receiving a second transmission package through the Internet transmission channel;
decompressing/decoding the second transmission package into second real-time video data and second real-time audio data; and
synchronizing the second real-time video and the second real-time audio data according to the time stamp, and outputting the second real-time audio data and video data in the game environment,

32. The method as claimed in claim 31, wherein the establishment of the Internet transmission channel further comprises the steps of:
designating an Internet address of a third external Internet game client by the Internet game client or the external Internet game client;
transmitting a connecting request to the third Internet game client by the Internet game client or the external Internet game client according to the Internet address; and
establishing the Internet transmission channel between the Internet game client and the third Internet game client.

33. The method as claimed in claim 31, wherein if the bandwidth of the internet transmission channel cannot transmit the first real-time audio data and the first real-time video data simultaneously, the first real-time audio data takes priority over first real-time video data.

34. The method as claimed in claim 31, wherein in the establishing step, the Internet transmission channel is established according to a directory, having an Internet address of the third external Internet game client.

35. The method as claimed in claim 31, wherein synchronization is achieved by adding the system time of the second internet game client to the time stamp to generate the display time of the second real-time video and audio data.

36. The method as claimed in claim 31, wherein synchronization is achieved by comparing the time stamp the amount of the frames dropped by the second real-time video data.

37. The method as claimed in claim 31, wherein playback of the second video data is accomplished by integrating the second real-time video data into the game environment as texture mapping.

38. A method of implementing real-time video-audio interaction by data synchronization in an internet game for applying in a first Internet game client and a second Internet game client, wherein the first and second Internet game client execute an Internet game and connect to an Internet game server, comprising the steps of:
establishing an Internet transmission channel between the first Internet game client and the second Internet game client, wherein the Internet transmission channel is not connected to the Internet game server;
retrieving first real-time video data and first real-time audio data in the first Internet game client;
producing a plurality of first video data frames and a plurality of first audio data packets;
packaging the first video data frames and the first audio data packets into a transmission package and attaching a time stamp into the transmission package, wherein the time stamp expresses the synchronous relationship between the first real-time video and audio data;
transmitting the transmission package to the second Internet game client;
decoding the transmission package into second real-time video data and second real-time audio data; and
synchronizing the second real-time audio and video data according to the time stamp, and outputting the second real-time audio data and video data in the Internet game in the second Internet game client.

39. The method as claimed in claim 38, wherein the establishing step further comprises the steps of:
designating an Internet address of the second Internet game client directly or according to a directory by the first Internet game client, wherein the directory includes the Internet address of the second Internet game client;
transmitting a connection request from the first Internet game client to the second Internet game client; and
establishing the Internet transmission channel by the second Internet game client in response to the connection request.

40. The method as claimed in claim 38, wherein the first real-time audio data is primarily packaged in the first transmission package, and the remaining bandwidth is used for packaging the first real-time video data.

41. The method as claimed in claim 38, wherein the first video data frames and the first audio data frames are produced by compressing/encoding.

42. The method as claimed in claim 38, wherein the transmission package is transmitted to the second Internet game client through the Internet transmission channel.

43. The method as claimed in claim 38, wherein the synchronization is based on system time of the second Internet game client adding the time stamp as display time of the second real-time video and audio data.

44. The method as claimed in claim 38, wherein synchronization is achieved by comparing the time stamp the amount of the frames dropped by the second real-time video data.

45. A system of implementing real-time video-audio interaction by data synchronization in an Internet game for application to a first Internet game client, a second Internet game client, and an internet game server, wherein the Internet game server executes an Internet game, the system comprising:
an Internet transmission channel, the first Internet game client and the second Internet game client connecting to the Internet game server to execute the Internet game, the Internet transmission channel coupled to the first and second Internet game clients to execute real-time video-audio interaction.
